(19) United States
(12) Patent Application Publication
(10) Pub. No.: US 2021/0049606 A1
(43) Pub. Date: Feb. 18, 2021

(54) APPARATUS AND METHOD OF FRAUD PREVENTION

(71) Applicant: Ocado Innovation Limited, Hatfield, Hertfordshire (GB)

(72) Inventors: Carlos GARCIA, Hatfield, Hertfordshire (GB); Laurent CANDILLIER, Hatfield, Hertfordshire (GB); Ernest STEPHENSON, Hatfield, Hertfordshire (GB)

(73) Assignee: Ocado Innovation Limited, Hatfield, Hertfordshire (GB)

(21) Appl. No.: 16/969,405

(22) PCT Filed: Feb. 12, 2019
(86) PCT No.: PCT/EP2019/053385

§ 371 Date: Aug. 12, 2020

(30) Foreign Application Priority Data
Feb. 13, 2018 (GB) 1802315.0

(51) Int. Cl. G06Q 20/40; G06Q 30/06; G06K 9/62; G06N 7/00

(52) U.S. Cl. CPC G06Q 20/4016; G06N 7/005; G06K 9/6256; G06Q 30/0633

(57) ABSTRACT

An apparatus and method are disclosed for fraud detection such that a large number of events per second of online activity/ordering are effectively reduced to a few cases of fraud by finding patterns in fraudulent orders. According to the present disclosure there is provided a fraud detection unit arranged to communicate with a customer order database, a customer order history database and a fraud statistics database. The fraud detection unit includes a training unit arranged to train a model based on customer order history information in a customer order history database and fraud statistics information in an fraud statistics database and a calculating unit arranged to calculate a probability of an order being fraudulent based on a trained model and customer order information in a customer order database.

This application claims priority from UK Patent Application No. 1802315.0 filed 13 Feb. 2018, the content of all this application hereby being incorporated by reference.

### TECHNICAL FIELD

The present invention relates generally to the field of electronic commerce and more specifically to an apparatus and method for providing fraud detection based on customer behaviour.

### BACKGROUND

The use of the Internet for conducting electronic commerce is well known. Many retailers now advertise and sell products online. Products of a wide variety are available for purchase online, including products which are electronically delivered to the purchaser over the Internet, for example music. Similarly, physical products, for example books, can be ordered online and delivered through conventional distribution means. Companies typically set up electronic versions of their catalogue, which are hosted on server computer systems, with lists of products available. A customer may browse through the catalogue using an Internet browser and/or a mobile application on a smart phone and select various products that are to be purchased. When the customer has completed selecting the products to be purchased, the server computer system then prompts the customer for information to complete the ordering of the products. This purchaser-specific order information may include the purchaser's name, the purchaser's credit card number, and a shipping address for the order. The server computer system then typically confirms the order by sending a confirming Web page/mobile application page to the client computer system and schedules shipment of the products.

The selection of the various products from the electronic catalogues is typically based on the model of a virtual shopping basket. When the purchaser selects a product from the electronic catalogue, the server computer system metaphorically adds that product to a virtual shopping basket. When the purchaser is done selecting products, then all the products in the shopping basket are “checked out” (i.e., ordered) at which point the purchaser provides billing and shipment information. In some models, when a purchaser selects any one product, then that product is “checked out” by automatically prompting the customer for the billing and shipment information.

For online retailers processing a relatively large number of orders per week, for example over one quarter of a million orders per week for hundreds of thousands of customers, millions of events are generated every minute on the web page/mobile application as customers browse the catalogue, add products to a virtual shopping basket, choose a delivery slot and “check out” their order. One challenge facing any retailer operating online is isolating and recognizing the rare incidents classified as online fraud in a smart and efficient way.

Online fraud typically covers any instance where an order is delivered but not paid for. Fraud can happen as a result of a genuine mistake (a customer entering the wrong personal details or using an expired credit card accidentally) but, occasionally, it can also be the result of malicious intent, these cases combined can amount to a number of orders being left unpaid each day.

Traditionally, fraud detection agents are employed to make judgement calls on whether they think a certain interaction is likely to be fraud or not. Decisions are based largely on intuition. For example, if a fraud agent notices a correlation between virtual baskets containing an unusually large order of alcohol and confirmed instances of fraud, they might then continue to look out for this trend in future. However, once fraudsters realise their strategy is less effective they move to a new strategy, for example using household goods.

Some online retailers use “anomaly detection” algorithms to detect fraud. For example, by detecting how similar an order is to previous orders of the customer. Anomaly detection may also be performed by the payment instrument holder and/or the financial service provider (bank) detecting variances from their “normal” behaviour over time, or in some cases, like with Stripe Radar detecting behaviour based on the payment card—either in usage across the transaction processing network or based on merchant averages. In the example of a credit card company, fraud is typically detected by looking at requests for authorisation based on value of transaction, name of merchant (for example, flagging those merchants never previously used by the customer), type of merchant, whether the customer has, unusually, switched merchants from one supplier to another.

However, fraudulent customers usually create new accounts, so these algorithms are not valid in such cases.

### SUMMARY

In view of the problems in known fraud detection systems, the present invention aims to provide an apparatus and method for such a fraud detection such that the large number of events per second are effectively reduced to the few cases of fraud.

In general terms, the invention finds patterns of fraudulent orders in a more general way by utilising advantageous business knowledge, for example, by deciding which products are more likely to be bought by a fraudulent customer.

According to the present invention there is provided a fraud detection unit arranged to communicate with a customer order database, a customer order history database and a fraud statistics database. The fraud detection unit comprises a training unit arranged to train a model based on customer order history information in the customer order history database and fraud statistics information in the fraud statistics database and a calculating unit arranged to calculate a probability of an order being fraudulent based on the trained model and customer order information in the customer order database.

The present invention also provides a system comprising a customer order database, a customer order history database, a fraud statistics database and a fraud detection unit as previously described.

The present invention also provides a fraud detection computer system comprising at least one fraud evaluator arranged to rely on at least one of heuristics and machine learning to evaluate fraud and an evaluation gateway arranged to configure the at least one fraud evaluator and evaluate the output of the at least one fraud evaluator.

The present invention also provides a method of detecting fraud, comprising the steps of training a model based on customer order history information stored in a customer order history database and fraud statistics information stored in a fraud statistics database and calculating a probability of an order being fraudulent based on the trained model and customer order information stored in a customer order database.

The present invention also provides a fraud detection method comprising the steps of providing at least one fraud evaluator relying on at least one of heuristics and machine learning to evaluate fraud, configuring the at least one fraud evaluator and evaluating the output of the at least one fraud evaluator.

### BRIEF DESCRIPTION OF THE DRAWINGS

Embodiments of the invention will now be described by way of example only with reference to the accompanying drawings, in which like reference numbers designate the same or corresponding parts, and in which:

FIG. 1 is a schematic diagram showing a fraud detection unit according to a first embodiment of the present invention.

FIG. 2 is a schematic diagram of a computer system architecture according to a first embodiment of the present invention.

FIG. 3 is a schematic diagram showing further detail of a fraud detection system.

FIG. 4 is a flowchart showing a method of fraud detection according to a first embodiment of the present invention.

### DETAILED DESCRIPTION OF EMBODIMENTS

### First Embodiment

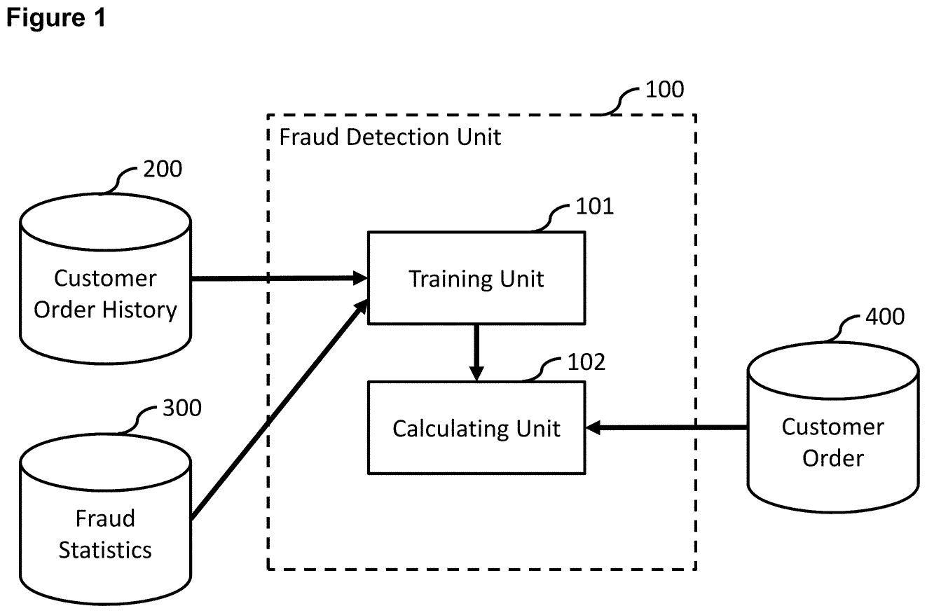

FIG. 1 depicts a fraud detection unit 100 according to the first embodiment of the present invention. In this embodiment the fraud detection unit 100 is arranged to communicate with a customer order history database 200, a fraud statistics database 300 and a customer order database 400.

The customer order history database 200 is arranged to store information about each customer and the products they have purchased over a predetermined period of time. For example, the last six months' worth of purchases. As will be explained later, the history of customer orders is used by the fraud detection unit 100 to train a model to thereby detect fraudulent orders. For example, the fraud detection unit 100 may be used in conjunction with an online shop from which a customer browses a catalogue of products, selects those to be purchased, “checks out” those products and makes a payment.

The fraud statistics database 300 is arranged to store information about fraud statistics. For example, fraud statistics on particular geographies to which fraudulent deliveries are usually delivered. Similarly, the fraud statistics database 300 may store information about e-mail addresses which have been used previously for fraudulent orders.

The customer order database 400 is arranged to store information about the customer together with information about the current order the customer is placing/has recently placed. For example the customer order database 400 may store information including the name of the customer, their email address, the address to which the order is to be delivered, the phone number of the customer etc. Moreover, the customer order database 400 may further store information specific to the order, for example, the delivery time of the order, details about the products in the order (for example, the number of alcoholic products in the order) or the total cost of the order.

The fraud detection unit 100 of the first embodiment of the present invention comprises a training unit 101 and a calculating unit 102.

The training unit 101 is arranged to train a model for calculating a probability of fraud. The model is trained based on customer order history information in the customer order history database 200 and fraud statistics information in the fraud statistics database 300.

The present inventors, having considered the disadvantageous previous solutions to the problem of fraud detection have effectively applied cloud and machine learning (ML) to the problem by way of the model trained by the training unit 101. Surprisingly, the present inventors have found that the application of ML to the specific application of fraud detection results in improved speed and adaptability, as compared to previous solutions. Moreover, as fraudsters change their tactics, the fraud detection unit can learn the new patterns more quickly than the previous solutions.

The machine learning model evolves based on the current environment and thereby predicts future trends.

The training unit 101 may utilise data collected from past orders (as stored in the customer order history database 200), including cases of fraud. The retrieved information may thereby be used as training data to train a more reliable model.

In this way, the training unit 101 utilises, for example, the following information from the customer order history database 200:
Historical behaviour of the customer (previous orders, previous fraudulent orders, products per order in the past and in the future, average price of order, etc.)

And from the fraud statistics database 300:
Account (fraud statistics on accounts based on name, email and account registration date)
Address (fraud statistics on postcodes or geographical areas)

The model may be trained a single time and then used by the calculating unit 102 thereafter. Alternatively, the model may be re-trained after a predetermined period of time to thereby update the model as the behaviour of customers and/or fraudsters changes. Moreover, the model may be trained “offline”, that is, separate from a particular shopping experience by a customer. In this way, the model need not be trained (which is a particularly computationally intensive process) whilst serving customers but instead calculated at a time when few customers are being served.

The calculating unit 102 is arranged to calculate a probability of an order being fraudulent based on customer order information in the customer order database. More specifically, the calculating unit 102 may utilise the model trained by the training unit 101 to thereby calculate a probability of an order being fraudulent order based on the information about the customer order being placed. When the probability exceeds a predetermined threshold, then the calculating unit 102 may be arranged to halt the order and/or alert an order manager that a fraudulent order has been detected. In this way, the processing of the order may be stopped (for example, by not delivering the products ordered and/or not charging the payment method of the customer). In one example, an order manager may inspect the order and determine whether to report the incident to police/fraud authorities for further investigation. Moreover, details of the order may be stored in the customer order history database 200 and marked as fraudulent which in turn may be used to train the model as to how to detect fraudulent orders.

In particular, the calculating unit 102 may utilise information about the products in the customer's virtual basket, together with customer specific information such, as the customer's address.

More specifically, for example, the following information may be used from the customer order database 400:
Payment (for example, information relating to a payment method type e.g. payment instrument type, card type, creation time, last usage and/or payment status)
Basket (for example, information about the current order being evaluated such as the number of items in the order, the total, delivery time, date and time the order was placed, booked delivery date, time left from placing order until delivery, variety of products in the order, promotions and vouchers used, total price of the order)
Items in the order (for example, specifics about items bought with the current order such as whether such items are related/not related to fraudulent orders in the past and/or how often does this product appear in fraudulent/non-fraudulent orders)
History (for example, statistics about past orders of that customer)
Account (for example, fraud statistics on accounts with same name and email, account registration date)
Address (for example, fraud statistics about the delivery address, the postcode and/or geographical area where the order will be delivered, whether the postcode matches the delivery address)
Session (for example, characteristics of the session in which the order was placed as well as statistics of past sessions, behaviour of the customer whilst placing the order: time it took the customer to place the order, number of pages visited, etc.)
Categories (for example, frequency of item occurrences for each category of product in an order, number of products, total price (with and without discounts) of the order products, grouped by categories (alcohol, tobacco, fresh food, home products, etc.))

The above features may be used to train the model by the training unit 101 as well being used by the calculating unit 102 to calculate the probability of a fraudulent order.

Moreover, the at least one of the following may be trained into the model by the training unit 101 and/or used by the calculating unit 102 to calculate a probability that an order is fraudulent:
Whether the order contains cigarettes
Whether the email address in the customer account contains numbers, which can mean it has been generated by a machine for fraudulent purposes
Whether the postcode on the account has been used in previous orders with failed payments
Whether the email domain, e.g. @ripoffs.sc.am, has been linked to fraudulent orders in the past
Whether the phone number has been used in a previous order that was shown to be fraudulent.
Whether the total value of the alcohol in the order is unusually high
Whether most of the products in this order are alcoholic drinks, with few other products included
Whether the total value of this order is unusually high
Whether this order contains many of the same product, which might suggest they are intended for resale
Whether the delivery time is scheduled for many days ahead
Whether the order contains multiple cigarette brands, suggesting they might be intended for resale
Whether this order is paid for by PayPal and the total value is unusually high
Whether this account has past orders that were rejected as fraudulent
Whether the email address appears to be invalid
Whether the postcode on the account has been linked to fraud in the past
Whether the postcode provided by a customer is not accurate for the address provided by the customer.

These features are used in real time, together with the model, when a new order comes to system, in order to predict the probability of fraud of the new order compared to the aggregate data computed on past orders.

In this way, previous customer and order data is accessed from the customer order history database 200. The previous customer and order data is aggregated based on, for example, the above listed criteria (e.g. counting the number of products which are the same in the order). The data is then normalised and used to train the machine learning model. The model is then used for real-time predictions by the calculating unit 102.

Thereby, when a new order is placed, a probability of fraud is calculated. For this, data contained in the order (products, customer details, etc.) is used together with aggregated past data based on those attributes (e.g. how many orders did that customer place in the past? How many times did this brand of wine appear in fraudulent orders?) to merge past data with real time data.

The present inventors faced several challenges implementing such a fraud detection unit 100. In particular, response time during real-time predictions, probability of errors connecting to remote systems or bad accuracy of the machine learning algorithm were particularly difficult to solve.

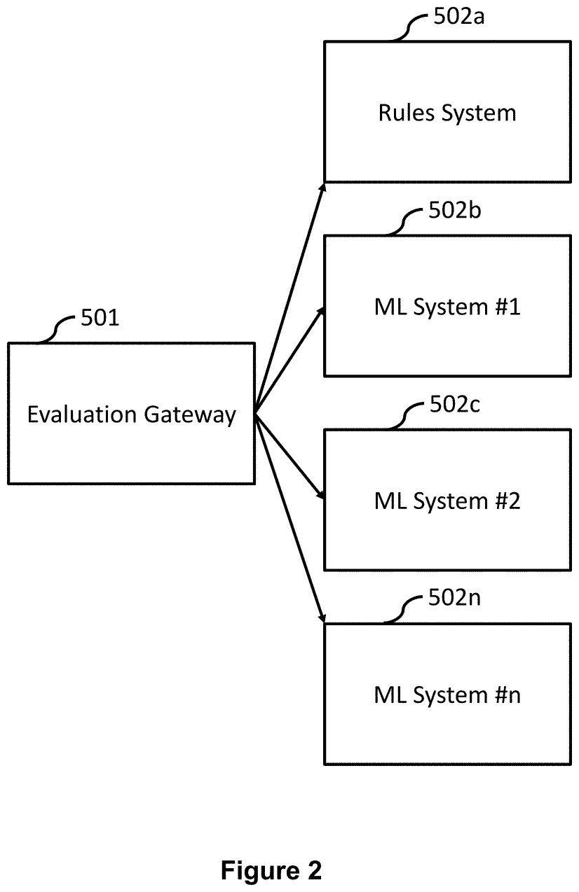

As shown in FIG. 2, in order to mitigate the impact of such issues, the present inventors designed a computer system architecture permitting the testing of several machine learning algorithms in production, without affecting the overall behaviour of the system if they were to fail.

Thereby, the present inventors devised a service arranged to act as a dispatcher, referred to as an Evaluation Gateway 501, calling at least one fraud evaluator 502a-502n. Each fraud evaluator 502a-502n may be arranged to rely on heuristic-based systems, such as the predefined rules, and also other systems based on machine learning.

The evaluation gateway 501 is arranged to allow configuring multiple fraud evaluators 502a-502n, with the following properties for each fraud evaluator:
State (Enabled, Disabled, or Audit). An enabled fraud evaluator will be performing its intended role, and contributing to the response of the evaluation gateway 501. A disabled fraud evaluator will not be called.
Percentage, indicating in what ratio this fraud evaluator contributes to the total response that the evaluation gateway 501 returns.

As an example, with three fraud evaluators (Ea, Eb, Ec) and the following configuration:
Ea:
   State: Enabled
   Percentage: 80%
Eb
   State: Audit
   Percentage: N/A
Ec:
   State: Enabled
   Percentage: 20%

Each fraud evaluator performs probability estimations independently. In this regard, the weights of the fraud evaluators needs not sum to 100% because the probability estimations are performed independently.

Moreover, assuming that a call to the evaluation service with a given set of parameters returns the following values, for example:
Ea: 80
Eb: 2000
Ec: 50

Thereby, the score calculated by the evaluation gateway 501 is, in this example, 74; which may be calculated as 0.8*80+0.2*50. The fraud evaluator Eb is in Audit mode and thus does not contribute to the score calculated by the evaluation gateway.

However, this is only one way of determining the final result of the fraud evaluators. Instead, the final result may be determined on a number of different ways. For example, the final results may be taken as an average of all results, a weighted average of the results and/or a ‘maximum score wins’ approach. Some evaluators can be disabled as already described.

The evaluation gateway 501 is built with resiliency and fault tolerance. If a call to a fraud evaluator takes longer than expected, that call will not affect the maximum response time defined for the evaluation gateway 501.

Similarly, if a call to a fraud evaluator 502n fails, the evaluation gateway 501 is arranged to allow defining a number of retries to that fraud evaluator 502n, and if eventually it does not succeed, the evaluation gateway 501 will return a score based on all successful fraud evaluators (fraud evaluator 502n being excluded).

In this way, several predictors are combined in a production environment.

The model described herein is retrained, for example by releasing it in audit mode and then enabling it with a small percentage that will be increased to see if it behaves as expected.

It could be applied to any system based on heuristic rules. Different types of problems can be approached with this architecture, for example classification problems (spam detection, fraud detection, etc.), regression problems (prediction of prices, demand forecasting, etc.) and even anomaly detection (user account hijack, stolen credit card, etc.)

The consolidated data using these two sources of data is then passed to the prediction endpoint.

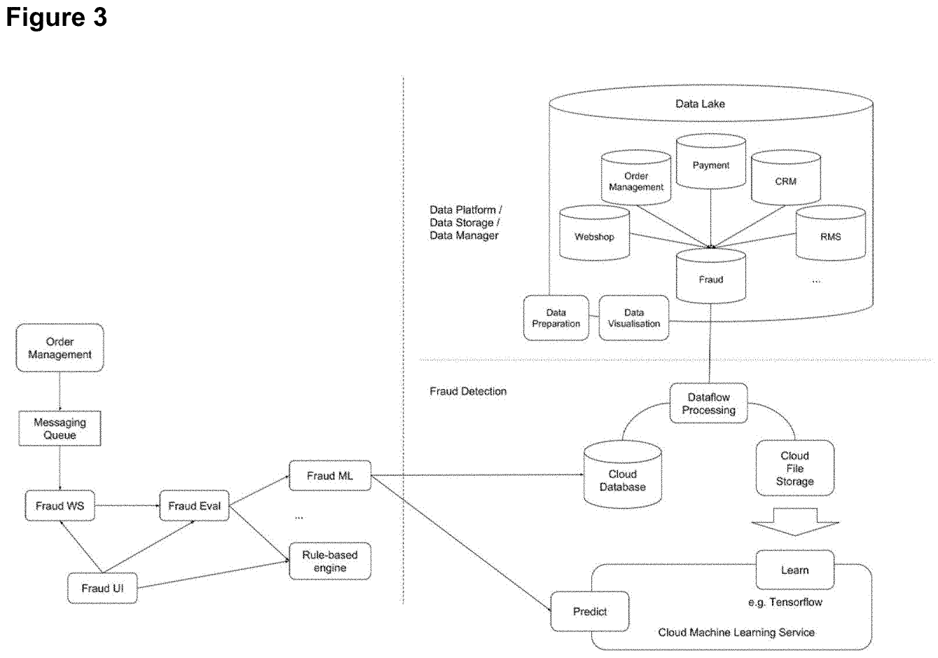

FIG. 3 is a diagram showing a detailed of the infrastructure which may be used to implement the fraud detection unit 100 together with other features. In particular, FIG. 3 shows an order placed by a customer being stored and used in a ‘Fraud WS’ which is used, together with ‘Fraud Eval’ to evaluate the fraud. As explained previously with regard to FIG. 2 the ‘Fraud Eval’ may be used to instantiate machine language and/or rule-based engines to evaluate whether fraud has occurred in a customer order. In this regard, FIG. 3 shows a Fraud detection subunit arranged to use the output of the machine learning evaluator, together with information from a data platform/data storage/data manager to determine a probability that fraud has been committed.

In particular, the data platform/data storage/data manager is arranged to retrieve information concerning previous orders (for example, products previously purchased by the customer), customer behaviour (in the online shop—webshop—whilst purchasing the order) and in payment (for example, methods of payment used, which methods typically result in fraudulent orders) as well as further information regarding the customer. The retrieved data is used to train the ML engine, as referred to previously with regard to the training unit 101.

The output of the Fraud ML is shown being used, together with the trained model, to predict whether fraud has been committed by the customer.

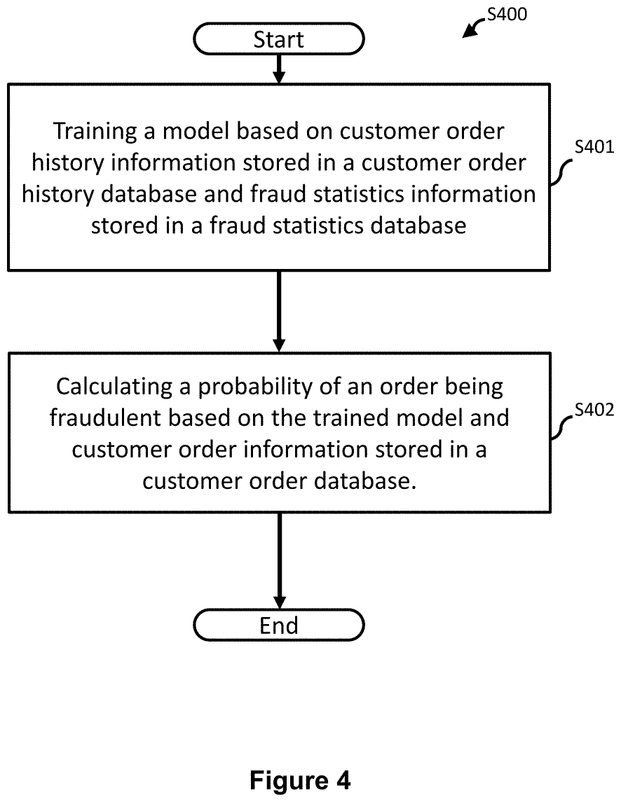

FIG. 4 shows a flowchart with steps performed by a method S400 of operating a fraud detector according to a first embodiment of the present invention.

The method S400 starts with a first step S401 of training a model based on customer order information stored in a customer order history database and fraud statistics information stored in the fraud statistics database. In this way, the model is trained based on historic information about previous customers' orders, which includes information about previous fraudulent orders. Moreover, this model is trained on information concerning typical characteristics of fraudulent orders, based on information in the fraud statistics database. For example, the fraud statistics database may comprise information concerning typical postcodes and/or geographical area to which fraudulent orders are typically ordered for delivery. Similarly, IP addresses of computers and/or Internet Service Providers used by those computers to place fraudulent orders may be stored in the fraud statistics database for use in training the model. Thereby, the model is trained based on previous fraudulent order information.

In step S402 the model is used, together with information about an order being/just placed by a customer to calculate a probability that the order being/just placed is a fraudulent order. More specifically, the calculating step S402 calculates a probability of an order being fraudulent based on the trained model and customer order information stored in the customer order database. For example, the customer order database may comprise information about the order being/just placed by the customer such as products ordered, whether these products have been ordered before, the address to which they are to be delivered, payment method used and total price of the order. In this way, the order information is used together with the model to calculate the probability of whether this order is fraudulent.

### Modifications and Variations

Many modifications and variations can be made to the embodiments described above, without departing from the scope of the present invention.

For example, the above described first embodiment may use ‘embeddings’ (also referred to as ‘word embeddings’) to determine the similarity of products and/or the similarity between orders placed by the customer such as customer order history information. In this regard, ‘embeddings’ may be referred to as ‘product embeddings’. A product embedding assigns, to every product, a mathematical vector of a predetermined length, for example, a cucumber may be represented as [1.0, −0.9, 7.0], i.e. a vector of real numbers. Such a representation has many advantages, especially when used with machine learning. In particular, product embeddings allows for easier definitions of similar and complementary products to help better discover relationships between products. Equally, such a technique may be applied to a customer's order to determine similarities therebetween. Moreover, it permits the discovery of patterns in customer behaviours, and understand customer shopping basket content. In this way, a product is mathematically embedded from a space with one dimension per product to a continuous vector space with a lower dimension.

In particular, the training unit may be arranged to train a model based on at least one similarity between information about a previous customer's order and another of the customer's previous orders stored in the customer order history database based on embeddings. For example, each order may be assigned a mathematical vector (the mathematical vector being stored in the customer order history database) and similarities between orders determined based on the stored mathematical vectors.

Additionally or alternatively, each product in a customer's previous orders may be assigned a product embedding. In this way, similarities between orders may be determined by comparing the similarities between products (using the product embeddings) so as to determine the overall similarity of previous orders.

Examples of software which may be used with regards to product embeddings are “word2vec” and/or “doc2vec”. Word2vec provides efficient estimation of work representations in vector space whilst doc2vec provides distributed representations of sentences and documents.

A further modification to the above described first embodiment is to utilise customer feedback to further train the model and thereby reduce false positives of fraud. In particular, the feedback loop extends beyond the customer features described previously (for example, using a customer's order history to determine whether an order is fraudulent). In this modification, when an order is determined to be fraudulent the customer is informed that a fraudulent order has been placed. In this scenario, when the order is marked as fraudulent, no charge will made to the customer's payment method and the order will not be shipped to the customer. This suitably defends against fraudsters by preventing the fraudsters from receiving the order whilst defending the customer by not charging the customer's payment method.

However, in some cases the order may have been a genuine customer order that was mistaken for a fraudulent order. Therefore, in this example, the customer will be informed that the order has been marked as fraudulent and will not be shipped. For example, the customer may receive an email or text message indicating the placement of an order believed to be fraudulent. The message may include information inviting the customer to contact customer services if the order is not fraudulent.

When the customer realises that an order genuinely placed by them has been marked as fraudulent they will contact customer services to confirm the order is genuine. Accordingly, the order will be shipped and the customer's payment method will be charged. Thereafter, future models may use this further information (such as contents of the order and that it was a genuine order) in the training of the model to reduce the likelihood that a similar order placed in the future will be marked as fraudulent. In this way, the experience for the customer is enhanced.

In this way, the present invention may be modified to improve the machine learning model utilising the above-described method to form a false positive feedback loop. More specifically, false positives data may be fed back into the training unit 101 to be used to improve the model. Whenever an evaluation is detected to be a false positive (e.g. when a customer telephones customer care to prove that a cancelled order was fraudulent) then the evaluation is recorded and used for re-training the model.

Another example modification is to detect when a fraudster is using a legitimate account, to which the fraudster has gained access, to commit fraud. This particular fraudulent act is not the same as ordering goods and not paying for them (which are previously described above) because, in this instance, the order will likely be paid for but later the owner of the account may realise the fraud and then request a chargeback i.e. a refund of the money paid for the order. Such malicious orders are harder to detect because they use legitimate accounts. However, by employing the ML technique described above then data may be included in the model (such as via re-training) using information about a user session (such as, whether a change in web browser is detected and/or change of IP address) and address (such as the order being shipped to a newly added address) as well as other properties of the order. In this way, further features of the order are used to detect the illegitimate use of a user's account.

The foregoing description of embodiments of the invention has been presented for the purpose of illustration and description. It is not intended to be exhaustive or to limit the invention to the precise form disclosed. Modifications and variations can be made without departing from the spirit and scope of the present invention.

1. A fraud detection unit arranged to communicate with a customer order database, a customer order history database and a fraud statistics database, the fraud detection unit comprising:
a training unit configured and arranged to train a model based on customer order history information from a customer order history database and fraud statistics information from a fraud statistics database; and
a calculating unit configured and arranged to calculate a probability of an order being fraudulent based on a trained model and customer order information from a customer order database.

2. The fraud detection unit according to claim 1, wherein the training unit is configured and arranged to train the model based on at least one or more of:
historical behaviour of a customer;
content of customers' previous orders;
previous fraudulent orders;
products per order;
average price of an order;
fraud statistics on accounts based on name, email and/or account registration date;
fraud statistics on postcodes and/or geographical areas;
payment information;
basket information;
items in an order information;
historical information;
account information;
address information;
session information; or categories information.

3. The fraud detection unit according to claim 1, wherein the training unit is configured and arranged to re-train the model after a predetermined period of time.

4. The fraud detection unit according to claim 1, wherein the training unit is configured and arranged to train the model separately from a particular shopping experience by a customer.

5. The fraud detection unit according to claim 1, wherein the calculating unit is configured and arranged to calculate the probability of an order being fraudulent based on at least one or more of:
payment information;
basket information;
items in an order information;
historical information;
account information;
address information;
session information;
categories information;
payment status;
payment method;
date and time an order was placed;
booked delivery date;
time left from placing order until delivery;
variety of products in an order;
promotions and vouchers used;
total price of an order;
products in an order;
how often does a product appear in fraudulent/non-fraudulent orders;
fraud statistics on accounts with same name, email and/or account registration date;
fraud statistics on a postcode and/or geographical area where an order will be delivered;
behaviour of a customer while placing an order;
time taken by a customer to place an order;
number of pages visited by a customer when placing an order;
number of products in an order;
total price, with and without discounts, of an order products, grouped by category;
whether an order contains cigarettes;
whether an email address in a customer account contains numbers;
whether a postcode on an account has been used in previous orders with failed payments;
whether an email domain has been linked to past fraudulent orders;
whether a phone number has been used in a previous order that was shown to be fraudulent;
whether a total value of an alcohol in an order is unusually high;
whether most products in an order are alcoholic drinks;
whether a total value of an order is unusually high;
whether an order contains many of a same product;
whether a delivery time is scheduled for many days ahead;
whether an order contains multiple cigarette brands;
whether an order is paid for by PayPal and a total value is unusually high;
whether an account has past orders that were rejected as fraudulent;
whether an email address appears to be invalid; or whether a postcode on an account has been linked to past fraud.

6. The fraud detection unit according to claim 1, wherein the calculating unit is configured and arranged to, when the calculated probability exceeds a predetermined threshold, perform at least one or more of:
determine that an order is fraudulent;
halt a processing of an order;
halt a delivery of an order;
halt taking payment from a customer payment method;
alert police/fraud authorities that a fraudulent order has been detected;
alert an order manager that a fraudulent order has been detected;
store details of a fraudulent order in a customer order history database;
or cause the training unit to retrain the model with details of a fraudulent order.

7. A system, comprising in combination:
a customer order database;
a customer order history database;
a fraud statistics database; and
a fraud detection unit according to claim 1.

8. A fraud detection computer system, comprising:
at least one fraud evaluator configured and arranged to rely on at least one of heuristics and machine learning to evaluate fraud; and
an evaluation gateway arranged to configure the at least one fraud evaluator and evaluate an output of the at least one fraud evaluator.

9. The fraud detection system according to claim 8, wherein the at least one fraud evaluator is arranged and configured to be enabled, disabled or audited, and configured to contribute a predetermined portion of an output of the at least on fraud evaluator to the evaluation gateway.

10. The fraud detection system claim 9, wherein the evaluation gateway is configured and arranged to allow a predetermined number of retries of evaluation to be performed on the at least one fraud evaluator.

11. A method of detecting fraud, comprising:
training a model based on customer order history information stored in a customer order history database and fraud statistics information stored in a fraud statistics database; and
calculating a probability of an order being fraudulent based on the trained model and customer order information stored in a customer order database.

12. The method according to claim 11, wherein the training includes training the model based on at least one or more of:
historical behaviour of a customer;
content of customers' previous orders;
previous fraudulent orders;
products per order;
average price of an order;
fraud statistics on accounts based on name, email and/or account registration date;
fraud statistics on postcodes and/or geographical areas;
payment information;
basket information;
items in an order information;
historical information;
account information;
address information;
session information; or categories information.

13. The method according to claim 12, wherein a training unit is configured and arranged to re-train the model after a predetermined period of time.

14. The method according to claim 13, wherein a training unit is configured and arranged to train the model separately from a particular shopping experience by a customer.

15. The method according to claim 14, wherein a calculating unit is configured and arranged to calculate the probability of an order being fraudulent based on at least one or more of:
payment information;
basket information;
items in an order information;
historical information;
account information;
address information;
session information;
categories information;
payment status;
payment method;
date and time an order was placed;
booked delivery date;
time left from placing order until delivery;
variety of products in an order;
promotions and vouchers used;
total price of an order;
products in an order;
how often does a product appear in fraudulent/non-fraudulent orders;
fraud statistics on accounts with same name, email and/or account registration date;
fraud statistics on a postcode and/or geographical area where an order will be delivered;
behaviour of a customer while placing an order;
time taken by a customer to place an order;
number of pages visited by a customer when placing an order;
number of products in an order;
total price, with and without discounts, of an order products, grouped by category;
whether an order contains cigarettes;
whether an email address in a customer account contains numbers;
whether a postcode on an account has been used in previous orders with failed payments;
whether an email domain has been linked to past fraudulent orders;
whether a phone number has been used in a previous order that was shown to be fraudulent;
whether a total value of alcohol in an order is unusually high;
whether most products in an order are alcoholic drinks;
whether a total value of an order is unusually high;
whether an order contains many of a same product;
whether a delivery time is scheduled for many days ahead;
whether an order contains multiple cigarette brands;
whether an order is paid for by PayPal and a total value is unusually high;
whether an account has past orders that were rejected as fraudulent;
whether an email address appears to be invalid; or whether a postcode on an account has been linked to past fraud.

16. The method according to claim 15, wherein the calculating comprises, when the calculated probability exceeds a predetermined threshold, at least one or more of:
determining that an order is fraudulent;
halting a processing of an order;
halting a delivery of an order;
halting taking payment from a customer payment method;
alerting police/fraud authorities that a fraudulent order has been detected;
alerting an order manager that a fraudulent order has been detected;
storing details of a fraudulent order in a customer order history database;
or
causing the training to retrain the model with details of a fraudulent order.

17. A fraud detection method comprising the steps of:
providing at least one fraud evaluator relying on at least one of heuristics and machine learning to evaluate fraud;
configuring the at least one fraud evaluator; and
evaluating the output of the at least one fraud evaluator.

18. The fraud detection method according to claim 17, wherein the configuring comprises:
configuring the at least one fraud evaluator to be enabled, disabled or audited; and
providing a predetermined portion of an output of the at least on fraud evaluator.

19. The fraud detection method according to claim 18, comprising:
allowing a predetermined number of retries of evaluation to be performed on the at least one fraud evaluator.

20. A fraud detection unit according to claim 1, wherein a training unit is configured and arranged to re-train a model after a predetermined period of time.
